(19) United States
(12) Patent Application Publication
(10) Pub. No.: US 2003/0167212 A1
(43) Pub. Date: Sep. 4, 2003

(54) METHOD AND SYSTEM FOR PROVIDING RELEVANT ADVERTISEMENT INTERNET HYPERLINKS

(75) Inventor: Dante Monteverde, Barrington Hills, IL (US)

Correspondence Address: SEYFARTH SHAW, 55 EAST MONROE STREET, SUITE 4200, CHICAGO, IL, 60603-5803, US

(73) Assignee: EMERGENCY 24, INC., Chicago, IL (US)

(21) Appl. No.: 10/249,895

(22) Filed: May 15, 2003

(51) Int. Cl. G06F 17/60

(52) U.S. Cl. 705/26

(57) ABSTRACT

A method and system of providing a hyperlink to a first web site on a second web site comprising providing a first web site database having a plurality of first web site categories and a description of the content of the first web site, assigning the first web site to at least one of the first web site categories thereby defining a first category assignment, designating, in each respective first web site category, the first web site that is willing to award a greatest compensation amount a highest priority first web site, determining a relevant first web site category by comparing the second web site to the first web site categories, and displaying the description of the content for the highest priority first web site of the relevant first web site category on the second web site.

### BACKGROUND OF INVENTION

The present invention relates generally to Internet hyperlinking, and, more particularly, to a method and system for providing a relevant hyperlink to a first web site on a second web site.

In its purest form, the Internet is a group of interconnected computers that are linked together to form a worldwide network where individual documents on this network, commonly referred to as web sites, are further linked or interconnected to one another, via hyperlinks, to form the World Wide Web (the “Web”). Some businesses and individuals use web sites for informational purposes only, while others use web sites to promote ideas, products or services, and thus rely on the ability to attract as many Internet users as possible to that web site to promote such ideas, products or services. Whether a web site is for informational purposes or to conduct a business” transactions, the inability to attract Internet users interested in the web site, which are subsequently potential customers, is a problem associated with the Web.

A generally accepted method to promote a web site is provide a compensation-based system where a first web site is advertised on a second web site where the second web site subsequently directs Internet users to the first web site in exchange for some type of compensation. A typical affiliate program works by placing an advertisement of a first web site, such as in the form of a hyperlink, on a popular or heavily trafficked second web site. The second web site will generally place the hyperlink to the first web site that will pay the highest commission for such placement in order to maximize its revenues. If an Internet user clicks on the hyperlink to the first web site, a commission is typically awarded to the second web site for directing that Internet user to the first web site.

However, a limitation to this type of affiliate program is that the ability of the first web site to determine which web sites its advertisement or hyperlink is placed on is greatly limited. As such, its advertisement may be placed on a second web site that experiences Internet users with little or no interest in the first web site. Thus, the viability of directing Internet users to the first web site from the second web site is greatly diminished.

Further, second web sites have been known to mislead Internet users into following hyperlinks that do not accurately reflect the type of web site the first web site is by, for example, modifying the description of the first web site, simply to increase the second web site's commission by fraudulently directing users to the first web site.

### SUMMARY OF INVENTION

The present invention overcomes the disadvantages and/or shortcomings of known prior art and provides significant improvements thereover.

The present application discloses an Internet based advertising and referral system in which a targeted advertisement of a first web site, which may take the form of a hyperlink to the first web site, is presented to Internet users on a second web site. The advertisement may include, for example, a description of the content and/or title of the first web site.

The advertisement that is displayed is compiled from a database wherein a plurality of first web sites are prioritized, in respective categories, by a compensation-based bidding system where the highest paying first web site for a respective web site category is granted the priority to be displayed on a second web site. Further, in determining which advertisement is displayed on a second web site, the second web site is compared to the categories that the first web site is assigned to. As such, only relevant first web sites will be advertised on the second web site, thus greatly increasing the likelihood of attracting viable Internet users. Also, the information as provided in the database by the first web site, for example title of content and description of content, is displayed on the second web site wherein the second web site cannot manipulate or modify such information. As such, the information displayed is strictly controlled by the first web site.

When an Internet user follows the advertisement hyperlink on the second web site, the Internet user is transferred to the first web site and the second web site is awarded a commission for directing the Internet user to the first web site based upon the compensation that the first web site was willing to pay. It is anticipated that the first web site prioritization and/or information may be continually updated in the first web site database where newly prioritized first web sites can be automatically displayed on a second web site, which, again, is determined by the amount of compensation the first web site is willing to give to be placed on the second web site.

The present invention thus has the benefit of providing the second web site a hyperlink to a first web site that is willing to compensate the second web site the most, thus increasing the second web site's revenues. The first web site is benefited in that the type of second web sites that the hyperlink to the first web site is displayed on is controlled via the first web site database, and the second web site cannot alter the first web site's displayed information or mislead Internet users in order to boast awarded commissions, thus increasing viable, interested Internet users directed to the first web site.

### DETAILED DESCRIPTION

The present application discloses a method and system for providing information, such as content description or title, of a first web site on a second web site. The information may be displayed in the form of a hyperlink to the first web site.

In an embodiment, a first web site database is provided wherein the database includes a plurality of first web site categories. Each of the categories may broadly describe topics in the form of genus or may be specific, such as in the form of an anticipated keyword. It is anticipated that the categories will be encompassing to at least cover topics or keywords that an Internet user may be interested in.

Within the first web site database, information concerning at least one web site which would like to be advertised or promoted on another web site, herein designated the first web site, is provided.

The information may be controlled by the first web site operator and may include information concerning the first web site's content, in the form of a description, a descriptive title of the first web site and/or the Uniform Resource Locator (URL) of the first web site.

The first web site is assigned to at least one of the first web site categories to define a first web site category assignment. It is anticipated that a first web site may be assigned to either one first web site category or a plurality of first web site categories. The first web site may be assigned based upon the description of the content of the first web site, title of the first web site, or actively chosen by the first web site operator. As such, it is anticipated that the first web site will be assigned to at least one first web site category that is relevant to that first web site. The assignment may be either manual or computer-assisted.

In an embodiment, a second web site database may be provided which includes a plurality of second web site categories. The second web site categories may be the same as the first web site categories. Information concerning at least one web site which would like to advertise or promote another web site, herein designated the second web site, is provided. The information may take the form of a description of the content, title and/or URL of the second web site. The second web site is assigned to at least one of the second web site categories to define a second web site category assignment. Similar to the first web site category assignment, the second web site may be assigned based upon the description of the content of the second web site, title of the second web site, or actively chosen by the second web site operator. As such, it is anticipated that the second web site will be assigned to at least one second web site category that is relevant to or compliments that second web site.

A compensation-based bidding system is employed to determine the priority of the first web sites in each respective first web site category. A means for determining the greatest compensation amount each respective first web site is willing to award may be provided in the form of a bid management system wherein each first web site within the first web site database may provide compensatory bid amounts, wherein each first web site bids against each other first web site in the respective first web site categories. As such, the bid management system promotes a competitive environment between each of the first web sites based upon the respective first web site bid amounts. The first web site with the highest bid, in the form of the greatest compensation amount, in each respective first web site category is designated the highest priority first web site in that respective first web site category. It is anticipated that the greatest compensation amounts may constantly vary and may be dynamic, wherein the bid management system may allow for continual updating of the first web site compensation amount bidding. As such, the present invention ensures that that the first web site willing to award the greatest compensation amount for a promotion or advertisement is continually prioritized, wherein the highest awarding first web site is always determined to be the highest priority first web site. It is further anticipated that the bid management system will be nearly instantaneous with very minimal lag time from when a first web site bids a compensation amount and when the highest priority first web site is newly designated.

The compensation-based bidding system may include an interface for allowing the first web site owners to log into, thereby allowing the first web sites to dynamically change their bid or automatically enter a bid amount.

At least one relevant first web site category is determined by comparing the second web site to the first web site categories. As such, it is anticipated that the second web site will be matched to at least one first web site category that is relevant to or compliments that second web site. For example, if the second web site pertains to top soil or landscaping, the relevant first web site category may be flowers.

In another embodiment the second web site category assignment is matched to at least one first web site category that is relevant to or compliments the second web site category assignment, thereby defining a relevant first web site category.

The description of the highest priority first web site of the relevant first web site category is displayed on the second web site. The description is determined by the description provided by the first web site within the first web site category and, as such, is not modifiable by the second web site. The description may take the form of a description of the content of the first web site, a title of the first web site and the like. Further, a hyperlink to the highest priority first web site of the relevant first web site category is displayed on the second web site. In an embodiment, any portion of the highest priority first web site description or title may be in hyperlink form.

It is anticipated that an Internet user interested in either the title or description of the highest priority first web site of the relevant first web site category will use the hyperlink to be directed and transferred from the second web site to the highest priority first web site. If an Internet user follows the hyperlink from the second web site to the highest priority first web site, the second web site is awarded at least a portion of the greatest compensation amount the highest priority first web site was willing to award based upon the compensation-based bidding system. As such, with the present invention, the second web site is constantly ensured that it will be awarded the greatest amount available from the first web sites. In an embodiment, the second web site is awarded the full greatest compensation amount.

In an embodiment, a means for tracking if an Internet user uses and follows the hyperlink to the highest priority first web site from the second web site is provided. As such, the means for tracking will provide and create a tracked amount for computing an amount of compensation due from the highest priority first web site to the second web site wherein the amount of compensation due is mathematically determined by the greatest compensation amount and the tracked amount. For example, if the tracked amount accounts for 100 successful transfers to the highest priority first web site from the second web site wherein the highest priority first web site's greatest compensation amount is $0.50 per successful link, the compensation due the second web site may be a portion of the product of 100 transfers and $0.50 per transfer, or $50. It is anticipated that the system of the present invention will be awarded a portion of the compensation due for administrative fees and the like. Alternately, the second web site may be awarded the full amount.

While preferred and alternate embodiments have been described herein, it is to be understood that these descriptions are only illustrative and are thus exemplifications of the present invention and shall not be construed as limiting. It is to be expected that others will contemplate differences, which, while different from the foregoing description, do not depart from the true spirit and scope of the present invention herein described and claimed.

1. A method of advertising a first web site having content on a second web site, comprising:
providing a first web site database having a plurality of first web site categories and a description of the content of the first web site;
assigning the first web site to at least one of the first web site categories thereby defining a first category assignment;
designating, in each respective first web site category, the first web site that is willing to award a greatest compensation amount a highest priority first web site;
determining a relevant first web site category by comparing the second web site to the first web site categories; and
displaying the description of the content for the highest priority first web site of the relevant first web site category on the second web site.

2. The method of claim 1 further comprising providing a second web site database having a plurality of second web site categories.

3. The method of claim 2 further comprising assigning the second web site to at least one of the second web site categories thereby defining a second web site category assignment.

4. The method of claim 3 wherein the step of determining a relevant first web site category by comparing the second web site to the first web site categories includes comparing the second web site category assignment to the first web site categories.

5. The method of claim 1 further comprising displaying a hyperlink to the highest priority first web site of the relevant first web site category on the second web site.

6. The method of claim 5 further comprising awarding the second web site a portion of the greatest compensation amount if an Internet user is directed to the highest priority first web site via the hyperlink.

7. The method of claim 5 further comprising awarding the second web site the greatest compensation amount if an Internet user is directed to the highest priority first web site via the hyperlink.

8. The method of claim 1 wherein the step of assigning the first web site to at least one of the first web site categories thereby defining a first web site category assignment includes comparing the relevancy of the first web site to each of the first web site categories.

9. The method of claim 8 wherein the relevancy is manually compared.

10. The method of claim 3 wherein the step of assigning the second web to at least one of the second web site categories thereby defining a second web site category assignment includes comparing the relevancy of the second web site to each of the second web site categories.

11. The method of claim 10 wherein the relevancy is manually compared.

12. The method of claim 1 wherein the greatest compensation amount is determined by a bidding process wherein each respective first web site can bid against each other first web site within a respective first web site category.

13. The method of claim 12 wherein the bidding process includes a bid management system means having an interface for allowing the first web site to automatically enter a bid.

14. The method of claim 1 wherein the highest priority first web site is dynamically based upon the greatest compensation amount.

15. A method of providing a hyperlink to a first web site having content on a second web site, comprising:
providing a first web site database having a plurality of first web site categories and a description of the content of the first web site;
assigning the first web site to at least one of the first web site categories thereby defining a first category assignment;
designating, in each respective first web site category, the first web site that is willing to award a greatest compensation amount a highest priority first web site;
determining a relevant first web site category by comparing the second web site to the first web site categories;
displaying the description of the content for the highest priority first web site of the relevant first web site category on the second web site;
displaying a hyperlink to the highest priority first web site of the relevant first web site category on the second web site; and
awarding the second web site at least a portion of the greatest compensation amount if an Internet user is directed to the highest priority first web site via the hyperlink.

16. The method of claim 15 further comprising providing a second web site database having a plurality of second web site categories and assigning the second web site to at least one of the second web site categories thereby defining a second web site category assignment.

17. The method of claim 15 wherein the step of assigning the first web site to at least one of the first web site categories thereby defining a first web site category assignment includes comparing the relevancy of the first web site to each of the first web site categories.

18. The method of claim 17 wherein the relevancy is manually compared.

19. The method of claim 16 wherein the step of assigning the second web site to at least one of the second web site categories thereby defining a second web site category assignment includes comparing the relevancy of the second web site to each of the second web site categories.

20. The method of claim 19 wherein the relevancy is manually compared.

21. The method of claim 15 wherein the greatest compensation amount is determined by a bidding process wherein each respective first web site can bid against each other first web site within a respective first web site category.

22. The method of claim 21 wherein the bidding process includes a bid management system means having an interface for allowing the first web site to automatically enter a bid.

23. The method of claim 15 wherein the highest priority first web site is dynamically based upon the greatest compensation amount.

24. A system for placing a hyperlink to a first web site having content on a second web site, comprising:
a first web site database having a plurality of first web site categories and a description of the content of the first web site wherein the first web site is assigned to at least one of the first web site categories thereby defining a first web site assignment;
a means for determining a greatest compensation amount each respective first web site is willing to award including a bid management system for allowing each respective first web site to submit compensation amounts in the form of bids against each other first web site within a respective first web site category wherein the first web site with the greatest compensation amount is designated a highest priority first web site for the respective first web site category; and
a hyperlink to the highest priority first web site of a relevant first web site category being disposed on the second web site wherein the relevant first web site category is determined by comparing the second web site to the first web site categories, the hyperlink having the description of the content for the highest priority web site of the relevant first web site category.

25. The system as claimed in claim 24 further comprising a means for tracking if an Internet user uses the hyperlink to be directed to the first web site from the second web site thereby creating a tracked amount.

26. The system as claimed in claim 25 further comprising a means for computing an amount of compensation due from the first web site to the second web site wherein the amount of compensation due is determined by the greatest compensation amount and the tracked amount.
